(19) United States
(12) Patent Application Publication
(10) Pub. No.: US 2005/0185655 A1
(43) Pub. Date: Aug. 25, 2005

(54) Process for pre-emption of resources from a mobile communications network, with a view to establishing a service according to a maximum associated pre-emption rate

(75) Inventors: Patrick Blanc, Issy Les Moulineaux (FR); Nicolas Billy, Palaiseau (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/002,244

(22) Filed: Dec. 3, 2004

(30) Foreign Application Priority Data
Dec. 4, 2003 (FR) 03 14 277

(51) Int. Cl. H04L 12/28

(52) U.S. Cl. 370/395.41

(57) ABSTRACT

A mobile communications network comprises a core network (CN) connected to a radio access network (UTRAN). This network is constructed in such a way as to associate to each RAB, with a view to its establishment, a maximum rate for the pre-emption of resources from the network. Accordingly, when its radio access network (UTRAN) receives an RAB assignment request (associated to a requested rate and a maximum pre-emption rate) but there are insufficient resources available to allow the establishment of this RAB at the requested rate, it pre-empts resources from the network, which have previously been allocated to at least one other RAB, in order to perform the establishment of the RAB at a rate less than or equal to the maximum pre-emption rate associated to it.

The invention concerns the domain of mobile communications networks, and more specifically the establishment of services by pre-emption of resources from such networks.

Mobile communications networks, and notably those known as cellular networks, such as UMTS or GSM/GPRS networks for example, comprise a core network (CN) connected to a radio access network (RAN). The radio access network (RAN) contains nodes or (radio) network controllers such as RNCs (Radio Network Controllers) or BSCs (Base Station Controllers), whose task is to manage the allocation of the resources or logical channels on the network (such as radio link channels or channelisation codes) with a view to establishing services between mobile terminals and the core network (CN). A service (also known by the acronym RAB (for Radio Access Bearer) in the case of a UMTS network) consists for example of a connection that can be used to transmit data from the network to a mobile terminal (namely a downward transmission or downlink) or from a mobile terminal to the network (namely an upward transmission or uplink).

“Mobile terminal” is taken to mean all network equipment, mobile or itinerant, that is able to exchange data with a core network, via its radio access network. Accordingly, this could mean mobile phones, personal digital assistants (PDAs) or notebook computers equipped with a radio communication interface.

As those in the profession know, in CDMA (Code Division Multiple Access) type cellular networks, several mobile terminals can be active simultaneously, owing to the use of different spreading codes. In the case of downlinks, all mobile terminals located within the same cell share the output power of the base station (BTS or Node B of the RAN) that controls this cell.

When the output power of a cell reaches its maximum, theoretically the network can no longer establish any new RABs at this cell level. There is however a mechanism known as “pre-emption” which enables an RNC to pre-empt resources which it has previously allocated to an RAB associated to a low priority level, in order to reallocate them to an RAB to be established, associated to a higher priority level.

This preemption mechanism is defined, for an lu interface between the core network (CN) and a radio network controller (RNC), by specification 3GPP TS 25.413. The pre-emption data, associated to a given service type, is usually transmitted by the CN in the form of service parameters known as allocation/retention priority, integrated into the RAB assignment request.

The pre-emption mechanism therefore makes it possible, in the event of cell saturation, to force the establishment of a high-priority RAB to the detriment of a low-priority RAB, which is then released. This can be difficult to accept for the user whose mobile terminal is suddenly disconnected from the network. Moreover, the establishment of an RAB requesting a high rate can require the pre-emption of resources allocated to several low-priority RABs, and hence their release.

The aim of the invention is therefore to improve the situation.

Accordingly, the invention proposes a resource pre-emption process for the establishment of RABs which are associated to service parameters (with a requested rate), between mobile terminals and a radio access network on a mobile communications network.

This process is characterised by the fact that it consists, firstly, in associating a maximum rate to each RAB, with a view to its establishment, for the pre-emption of resources from the network, and, secondly, in the event of an RAB assignment request which is associated to a requested rate and a maximum pre-emption rate, and a lack of resources available to perform the establishment at the requested rate, in pre-empting resources from the network in order to perform the RAB assignment at a rate less than or equal to the maximum pre-emption rate associated to it.

The process, according to the invention, can include other features which could be employed singularly or in combination, of particular note:
a minimum rate can be associated to at least some of the different service types, corresponding to the quantity of resources that cannot be pre-empted from them,
resources can be pre-empted from the network in order to perform the establishment of an RAB at the maximum associated pre-emption rate,
when the minimum rate also defines the rate below which the establishment of an RAB is not allowed, then in the event of an RAB assignment request which is associated to a requested rate and to minimum and maximum pre-emption rates, and a lack of available resources to perform the establishment at the requested rate, resources can be pre-empted from the network in order to perform the establishment of an RAB at a rate between the minimum and maximum associated pre-emption rates,
an additional service parameter, which defines the maximum pre-emption rate associated to an RAB, can be integrated into each RAB assignment request intended for the radio access network. In this case, the additional service parameter can be integrated into a portion of the request containing the information element dedicated to the allocation/retention priority. When the information element portion includes a priority level parameter, a pre-emption capacity parameter, a pre-emption vulnerability parameter and a queuing parameter as standard, it is possible for example for the additional service parameter to be integrated after the queuing parameter,
as a variant or an addition, a service configuration table can be transmitted to the radio access network, establishing a correspondence between each service type and the associated service parameters, the latter including notably an additional service parameter defining the maximum pre-emption rate associated to the service type, in order that the radio access network can, upon receipt of an RAB assignment request, establish this RAB, taking into account the service parameters stored in its corresponding configuration table. In this case, it is possible for example to transmit the configuration table to the radio access network in O&M messages (Operation & Maintenance Messages),
when resource pre-emption is requested, it is possible to pre-empt all of the resources which have previously been allocated to at least one other pre-emptable RAB, and this is preferable when its rate cannot be downgraded,
as a variant or an addition, when resource pre-emption is requested, it is possible to pre-empt portions of resources which have previously been allocated to other pre-emptable RABs, and this is preferable when their respective rates can be downgraded. In this case, it is possible to pre-empt portions of resources that have previously been allocated to another pre-emptable RAB until there are sufficient resources available to establish the target RAB. Furthermore, it is possible to pre-empt resources that have been allocated to another pre-emptable RAB as long as sufficient resources remain for the RAB to be able to operate at its minimum associated rate,
when resource pre-emption is requested, it is possible to pre-empt resources that have previously been allocated to another pre-emptable RAB associated to the lowest priority level in relation to that of the RAB to be established.

The invention also proposes a mobile communications network comprised of a core network connected to a radio access network and constructed in such a way as to implement a resource pre-emption process of the type set out above.

The invention is particularly well suited, albeit non-exclusively, to UMTS and GSM/GPRS type cellular networks, as well as to wireless local area networks (WLANs).

Other features and advantages of the invention will be revealed upon examining the description detailed hereafter, and the appended drawing, on which the single FIGURE gives a schematic illustration of part of a UMTS type communications network, enabling the implementation of a resource pre-emption process in accordance with the invention. The appended drawing will not only serve to supplement the invention, but will also contribute to its definition, where appropriate.

The purpose of the invention is to enable the optimum pre-emption of resources within a mobile communications network, with a view to establishing an RAB.

Represented on the single FIGURE is part of a mobile communications network, of cellular type, more specifically of the UMTS type. Naturally, the invention can be applied to other types of mobile communications networks, particularly to GSM/GPRS type networks, and to wireless local area networks (WLANs).

As illustrated, a UMTS type cellular network can, in a very schematic manner but nonetheless sufficient for the purpose of understanding the invention, be typified as a radio access network or UTRAN (UMTS Terrestrial Radio Access Network), coupled by a so-called lu interface to a core network or CN, itself with the potential to be coupled to one or more other public and/or private networks (the link to these other networks is shown by the bi-directional arrow F).

The CN generally comprises a first service server, called 3G-SGSN (3G —Service GPRS Serving Node), responsible for transferring upstream and downstream packets of data between the UTRAN and the MS mobile terminals (or stations), and a second service server called 3G-GGSN (3G—Gateway GPRS Serving Node), coupled to the 3G-SGSN server and providing the role of logical interface between the UMTS network and the other public and/or private networks.

The CN also generally comprises a 3G-MSC (3G-Mobile Switching Centre) coupled to the lu interface and to at least one public wire network, such as a PLMN network (Public Land Mobile Network). The role of the mobile switching centre is to perform all of the operations required to manage communications in circuit mode with the MS mobile terminals.

Furthermore, the radio access network, hereafter referred to as the UTRAN, generally includes, firstly, several nodes or radio network controllers, also called RNCs, coupled to the CN via the lu interface and, secondly, several send/receive base stations, also called Node Bs, each associated to one or more cells C each covering one radio zone, and coupled singularly or by groups of at least two to one of the RNCs, via a logical interface.

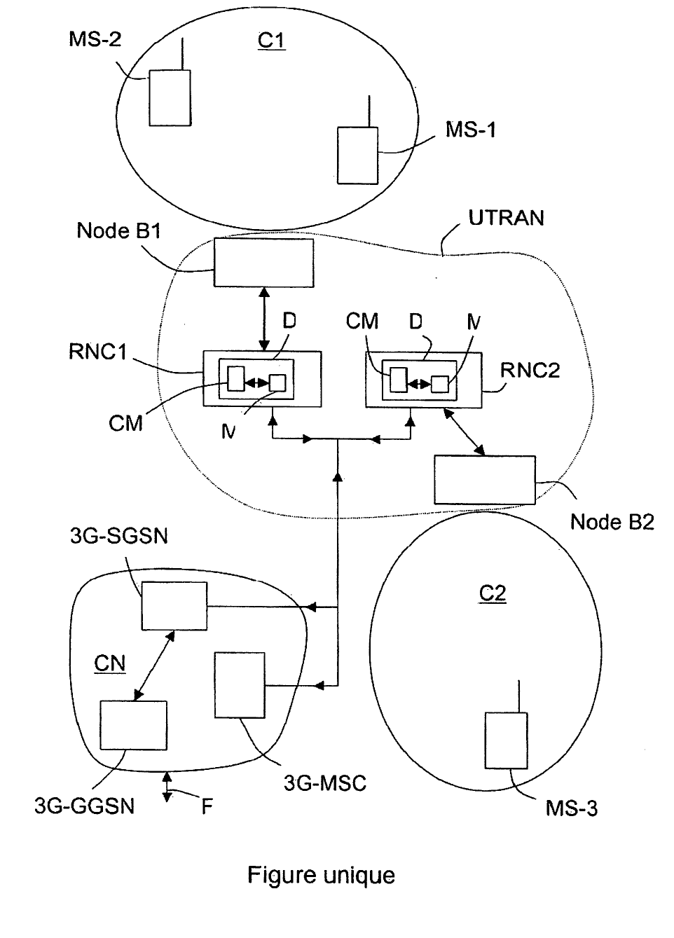

In the example illustrated in FIG. 1, the UTRAN contains only two RNCi (i=1 or 2) each coupled to a single Node Bj (here, j=1 or 2). Naturally, this is only a example illustrated, each Node Bj controls a single cell Cj defining a geographical zone (hereafter classed as the corresponding cell Cj). Naturally, the Node Bs could control several cells, and one geographical zone could be defined by several cells or portions of cells.

We also consider that the mobile terminals (or stations or even equipment) MS-k (here, k=1 to 3) located in each of the cells Cj are mobile telephones capable of exchanging data with other equipment on the network, and notably with the equipment on the UTRAN and the CN, in accordance with a communication protocol, such as WAP (Wireless Application Protocol) for example. But the invention is not limited to this type of mobile terminal. It also concerns PDAs (Personal Digital Assistants) and notebook computers equipped with a radio communication interface.

As specified in the introduction, the UMTS network has a pre-emption mechanism allowing its RNCs to pre-empt resources that they have previously allocated to RABs, established and associated to low priority levels, in order to reallocate them to other RABs which need to be established, associated to higher priority levels.

This pre-emption mechanism is defined, for the lu interface, by specification 3GPP TS 25.413, which can be accessed on the website http://www.3gpp.org According to this specification, each service type has pre-emption parameters (or data) associated to it, which are transmitted to an RNC by the CN, for example by its 3G-SGSN server, in the form of a Radio Access Bearer Assignment Request, or even an RANAP message), hereafter referred to as an RAB request, when an RAB must be established with a mobile terminal MS-k which is located in a cell Cj that it controls.

More precisely, an RAB request comprises a part called an information element dedicated to allocation/retention priority and which includes several parameters such as priority level, pre-emption capacity, pre-emption vulnerability and queuing.

Generally, the priority level can be set to a value of between 0 and 15, value 1 corresponding to the highest priority level and value 15 to the lowest priority level. The pre-emption capacity can be set either to a value that does not allow the associated RAB to trigger a pre-emption, or to a value that does allow the associated RAB to trigger a pre-emption. The pre-emption vulnerability can be set either to a value that does not allow the pre-emption of resources from the associated RAB, or to a value that does allow the pre-emption of resources from the associated RAB. Queuing can be set either to a value that does not allow the associated RAB request to be queued, or to a value that allows the associated RAB request to be queued with a view to being processed as soon as possible.

When the UTRAN, and more precisely one of its RNCs, receives an RAB request containing service parameters defining an RAB for which establishment is requested, this RNC performs a radio admission control in order to determine whether it has sufficient resources available to establish this RAB, taking into account its type. The service type is generally fully defined in the associated RAB, where it forms a supplement to the information element. Naturally, the RNC only performs this radio admission control on the condition that the RAB request contains a pre-emption capacity parameter with a value set to allow the associated RAB to trigger a pre-emption.

Service type is taken here to mean the service parameters such as traffic class, maximum bit rate, source statistics descriptor, and CN domain. Traffic class can generally use values representing the traffic types “conversational”, “interactive”, “background” and “streaming” respectively. The maximum bit rate can for example be set to values such as 12.2 kbps (kilobits per second), 64 kbps, 128 kbps or 384 kbps. The source statistics descriptor can be set to at least the “speech” value and the “unknown” value. The CN domain can be set to at least the CS (circuit switch) value and the PS (packet switch) value.

The resources needed to establish an RAB depend chiefly on its maximum bit rate.

In a standard UMTS network, when an RNC has sufficient resources to allow the establishment of the RAB at its maximum rate, it allocates the resources to the RAB. If however it does not, the RNC determines which RABs from those already established are associated to the lowest priority levels. It then pre-empts the resources previously allocated to at least one of these RABs in order to allocate them to the RAB targeted in the RAB request. In fact, the RNC pre-empts the quantity of resources that corresponds to the maximum rate of the RAB requested, the consequence of this being that one or more previously established RABs are released.

The invention proceeds in a different manner in order to avoid a situation where the resources allocated to RABs associated to low priority levels are systematically pre-empted to the benefit of RABs associated to higher priority levels.

To do so, the invention proposes to associate to each RAB, with a view to its establishment, a maximum (bit) rate for the pre-emption of resources from the network. As such, when an RNC on the UTRAN receives an RAB assignment request (associated to a requested (bit) rate and a maximum pre-emption rate) but there are insufficient resources available to allow the establishment of this RAB at the requested rate, it pre-empts resources from the network that have previously been allocated to at least one other RAB, in order to perform establishment of the RAB at a rate less than or equal to the maximum pre-emption rate associated to it.

In doing so, it is possible to significantly reduce the impact of the pre-emptions, and notably the number of released connections (or RABs) that they cause.

This impact can be reduced further if a minimum rate is associated to at least some of the different service types, corresponding to the quantity of resources that cannot be pre-empted from them. Effectively, in this embodiment, the RABs which can operate in downgraded mode (i.e. at a reduced rate) can no longer be released since they are assured of always having the available resources as correspond to their minimum rate.

The rate of establishment of the RAB being targeted is preferentially equal to the maximum pre-emption rate associated to it.

But, in a variant of this embodiment, the minimum rate can be used to define a rate below which the establishment of an RAB is not allowed. In this case, when an RNC in the UTRAN receives an RAB request (associated to a requested (bit) rate, a maximum pre-emption rate and a minimum pre-emption rate) but there are insufficient resources available to allow the establishment of this RAB at the requested rate, resources previously allocated to at least one other RAB are preempted from the network, in order to perform the establishment of the RAB at a rate somewhere between the minimum and maximum associated pre-emption rates. This lends a certain degree of flexibility to the network and further reduces the impact of the pre-emptions.

A maximum pre-emption rate (just like a minimum pre-emption rate) can be associated in at least two different ways.

The first way consists in leaving the aforementioned 3GPP standard unchanged, notably the lu interface between the CN and the RNCs. This provides for the use of a service configuration table, which establishes a correspondence between each service type and the associated service parameters, including an additional service parameter which defines the maximum pre-emption rate associated to the service type (and potentially one other additional service parameter which defines the minimum rate associated to the service type). Such a table will therefore include the following parameters, for each service type listed: traffic class, maximum bit rate, source statistics descriptor (SSD), CN domain, allocation/retention priority level, pre-emption capacity (allocation/retention), pre-emption vulnerability (allocation/retention), queuing, and maximum pre-emption rate.

An example of a configuration table is given below.

| Traffic | Max rate | | CN | Pre-emption | Pre-emption | Priority | | Max pre-emption |
|---|---|---|---|---|---|---|---|---|
| class | (kbps) | SSD | domain | capacity | vulnerability | level | Queue | rate (kbps) |
| Conver | 12.2 | Spe | CS | Mtp | P | 1 | NA | 12.2 |
| Conver | 12.2 | Spe | CS | Mtp | P | 15 | NA | 4.95 |
| Interac | 384 | Unk | PS | Mtp | P | 1 | NA | 384 |
| Interac | 384 | Unk | PS | Mtp | P | 7 | A | 128 |
| Interac | 384 | Unk | PS | Mtp | P | 15 | A | 64 |
| Backg | 384 | Unk | PS | Mtp | P | 1 | A | 128 |
| Backg | 384 | Unk | PS | Mtp | P | 7 | A | 64 |
| Backg | 384 | Unk | PS | Mtp | P | 15 | A | 32 |

In this table, “Conver” means “Conversational”, “Interac” means “Interavtive”, “Backg” means “Background”, “SSD” means “Source Statistics Descriptor”, “Spe” means “Speech”, “Unk” means “Unknown”, “Mtp” means “May trigger pre-emption”, “P” means “Pre-emtable”, “NA” means “Not allowed”, and “A” means “Allowed”.

This type of table is generated for example by the CN, and more precisely by its 3G-SGSN server (for packet mode) or its 3G-MSC mobile switching centre (for circuit mode), and transmitted to the relevant RNCs on the UTRAN by means of messages, preferentially O&M Messages (Operation & Maintenance Messages). So each RNC, in a memory M for example, has a configuration table which allows it to set its configuration each time it receives an RAB assignment request, or in other words to allocate resources which correspond either to the maximum pre-emption rate associated to the requested RAB, or to the interval between the minimum and maximum pre-emption rates associated to the requested RAB. In effect, it simply needs to recognise the service type requested, then to access the memory M, in order to determine the maximum associated pre-emption rate (or the interval between the minimum and maximum associated pre-emption rates).

The configuration within an RNC can be managed, for example, by a configuration module MC that belongs, as illustrated, to a configuration device D that could potentially contain the memory M. Such a configuration device D, and notably its configuration module MC, and potentially its memory M, can be achieved in the form of electronic circuits, software modules (or computing modules), or a combination of circuits and software.

Another method consists in slightly modifying the aforementioned 3GPP standard, and notably the lu interface between the CN and the RNCs. More precisely, it uses an additional service parameter which defines the aforementioned maximum pre-emption rate that needs to be associated to an RAB of a given type. Naturally, as indicated earlier, another additional service parameter can be used to define the aforementioned minimum pre-emption rate that needs to be associated to an RAB of a given type.

This (or these) additional service parameter(s) is (are) preferentially integrated by the CN, and more precisely by its 3G-SGSN server (or the 3G-MSC in circuit mode) in the RAB request that it transmits to an RNC on the UTRAN when it wants it to establish an RAB. In this case, each additional service parameter is preferentially integrated into the portion of the RAB request that contains the information element dedicated to allocation/retention priority. This integration can be made for example after the last standard parameter of the information element, in other words the queuing parameter.

Thus, when an RNC on the UTRAN receives an RAB assignment request, it extracts the service data from it, notably the maximum pre-emption rate (and potentially the minimum pre-emption rate) in order to configure itself accordingly, as indicated above. The configuration can be managed, as indicated above, by a configuration device D implanted in the RNC (which, in this case, does not need to include any memory M).

As indicated earlier, this embodiment requires a modification to the lu interface protocol so that it is able to support RAB requests that contain one or two additional service parameters.

For illustration purposes, firstly, an RAB associated to a conversational traffic class, a maximum requested rate of 12.2 kbps and a priority level equal to 1, can be associated to a maximum pre-emption rate of 12.2 kbps (unchanged), secondly, an RAB associated to an interactive traffic class, a maximum requested rate of 384 kbps and a priority level equal to 15, can be associated to a maximum pre-emption rate of 64 kbps, and thirdly, an RAB associated to a background traffic class, a maximum requested rate of 384 kbps and a priority level equal to 7, can be associated to a maximum pre-emption rate of 64 kbps.

According to the invention, at least three pre-emption modes can be envisaged.

The first mode consists in pre-empting all of the resources which have previously been allocated to at least one other pre-emptable RAB. In this case, in order to take account of the RABs which are pre-emptable and which support operation at a downgraded rate, such as those of an interactive or background type traffic class and a PS (packet mode) type CN domain, only the resources allocated to RABs which do not support operation at a downgraded rate are pre-empted, such as those with a conversational type traffic class and CS type CN domain (such as video services on the lu-CS interface (CS64) with the 3G-MSC mobile switching centre (circuit mode)).

Thus, only those communications involving RABs with a rate which cannot be downgraded can have their resources pre-empted and therefore their connections (or links) released.

The second mode consists in pre-empting only portions of resources which have previously been allocated to pre-emptable RABs. In this case, in order to taken account of those RABs which are pre-emptable but which do not support operation at a downgraded rate, only portions of the resources which are allocated to RABs which support operation according to downgraded mode are preempted.

In this case, the pre-emption operation can happen in several stages during which the relevant RNC successively pre-empts portions of resources which have been allocated to other pre-emptable RABs until it has sufficient resources to establish the target RAB. It is also possible to successively pre-empt portions of resources allocated to a pre-emptable RAB in order to establish several requested RABs, as long as sufficient resources remain for it to be able to operate at its minimum associated rate.

In this second mode, only the communications involving RABs with a rate which can be downgraded can have their resources pre-empted up to their minimum associated rates. This mode of pre-emption has the advantage of never interrupting a communication. The only feature that the end user may notice to be slightly deteriorated is the quality of service (QoS).

A third mode consists in combining the first and second modes set out above. More specifically, in the case of a substantial requirement for resources, all of the resources allocated to an RAB with a rate which cannot be downgraded, together with a portion of the resources allocated to one or more RABs with a rate which can be downgraded, are subject to pre-emption.

The different embodiments (or operation modes), which have been set out above, can also be used to take account of the priority levels of the established and requested RABs. More specifically, it is preferable to pre-empt only those resources which have been allocated to RABs with priority levels which are lower than that of the requested RAB. It is even more preferable to pre-empt only those resources which have been allocated to RABs with priority levels which are the lowest in relation to that of the requested RAB.

Thanks to the invention, it is possible to limit the impact of the pre-emption of resources in favour of RABs associated, notably, with high priority levels and high rates, particularly on RABs associated to low priority levels. This makes it possible to facilitate the introduction of the pre-emption mechanism on the mobile networks. Furthermore, this enables the operators to more easily control the properties of the pre-emption mechanisms on their mobile networks.

The invention is not limited to the mobile communications network, configuration device and resource pre-emption process embodiments described above—purely for illustrative purposes—but rather it encompasses all the variants which those in the profession could envisage within the context of the claims set out below.

Accordingly, we have thus far described one implementation of the invention in packet mode, but the invention also applies in circuit mode.

1. Process of pre-empting resources for the establishment of a service, associated to service parameters including requested rate, between a mobile terminal (MS) and a radio access network (UTRAN) on a mobile communications network, characterised in that it comprises: i) associating to each service a maximum rate for the pre-emption of resources from the network, with a view to its establishment, and ii) in the event of an assignment request for a service associated to a requested rate and to a maximum pre-emption rate and of a lack of available resources to perform the establishment at said requested rate, preempting resources from the network in order to perform said service establishment at a rate less than or equal to said maximum associated pre-emption rate.

2. Process according to claim 1, characterised in that at least some of said services have a minimum rate associated to them corresponding to a quantity of resources which cannot be pre-empted.

3. Process according to claim 1, characterised in that network resources are pre-empted so as to perform the establishment of a service at the maximum associated preemption rate.

4. Process according to claim 1, characterised in that the minimum rate also defines a rate below which the establishment of a service is not allowed, and in that in the event of a service assignment request associated to a requested rate and to minimum and maximum pre-emption rates and of a lack of available resources to perform the establishment at said requested rate, resources are pre-empted from the network so as to perform the establishment of said service at a rate between the said minimum and maximum associated preemption rates.

5. Process according to claim 1, characterised in that an additional service parameter, defining a maximum associated pre-emption rate associated to a service, is integrated into each service assignment request intended for said radio access network (UTRAN).

6. Process according to claim 5, characterised in that said additional service parameter is integrated into a portion of said request called “information element”, dedicated to the allocation/retention priority.

7. Process according to claim 6, characterised in that when said information element portion contains a priority level parameter, a pre-emption capacity parameter, a vulnerability parameter and a queuing parameter, said additional service parameter is integrated after said queuing parameter.

8. Process according to claim 1, characterised in that a service configuration table is transmitted to said radio access network (UTRAN), establishing a correspondence between each service type and the associated service parameters, the latter containing an additional service parameter defining a maximum pre-emption rate associated to said service type, in such a way that said radio access network (UTRAN) is able, upon receipt of a service assignment request, to proceed with the establishment of said service taking account of the service parameters stored in said configuration table as corresponding to its type.

9. Process according to claim 8, characterised in that said configuration table is transmitted to said radio access network (UTRAN) in operating and maintenance messages.

10. Process according to claim 1, characterised in that in the event of a requirement for the pre-emption of resources, all of the resources allocated to at least one other already established pre-emptable service are pre-empted.

11. Process according to claim 10, characterised in that all of the resources allocated to said other pre-emptable service are pre-empted when its rate cannot be downgraded.

12. Process according to claim 1, characterised in that in the event of a requirement for the pre-emption of resources, portions of resources allocated to other already established pre-emptable services are pre-empted.

13. Process according to claim 12, characterised in that said portions of resources allocated to said other pre-emptable services are pre-empted when their respective rates can be downgraded.

14. Process according to claim 12, characterised in that portions of resources allocated to another pre-emptable service are pre-empted until sufficient resources are available to establish the target service.

15. Process according to claim 2, characterised in that portions of resources allocated to another pre-emptable service are pre-empted until sufficient resources are available to establish the target service and in that the resources allocated to another pre-emptable service are pre-empted as long as sufficient resources remain for it to be able to operate at its minimum associated rate.

16. Process according to claim 1, characterised in that in the event of a requirement for the pre-emption of resources, the resources allocated to another pre-emptable service associated to the lowest priority level in relation to the priority level of the target service are pre-empted.

17. Mobile communications network comprising a core network (CN) connected to a radio access network (UTRAN), characterised in that it is constructed in such a way as to implement the resource pre-emption process according to claim 1.
